(19) United States
(12) Patent Application Publication
(10) Pub. No.: US 2003/0191801 A1
(43) Pub. Date: Oct. 9, 2003

(54) Method and apparatus for enabling services in a cache-based network

(76) Inventor: Sanjoy Paul, Marlboro, NJ (US)

Correspondence Address: Charles I. Brodsky, 2 Bucks Lane, Marlboro, NJ, 07746, US

(21) Appl. No.: 10/099,958

(22) Filed: Mar. 19, 2002

(51) Int. Cl. G06F 15/16

(52) U.S. Cl. 709/203; 709/227

(57) ABSTRACT

In a communications network deploying caches or proxy servers, an improvement is described utilizing a separate cache to aggregate requests and responses according to a protocol between the deployed cache and an application server.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the downloading of web-pages in Internet use.

2. Description of the Related Art

As is known, the World Wide Web (WWW) has become part of everyday life for a vast majority of people on the planet. However, the speed of downloading web-pages varies significantly from continent to continent, from country to country and even within a country depending on the time of day. There are two main reasons for this delay. First, the access bandwidth (also called the last-mile bandwidth) is typically 20-40 kbps for most Internet users. Second, the origin servers (which have the content) are so far away from the end-user (typically 15 router-hops) that the end-to-end path between the origin server and the end-user has a very high likelihood of being congested, leading to trickling of data bytes along the connection. While the first problem is being addressed by broadband connections like cable or xDSL or broadband wireless, the second problem is being addressed by deploying network caches at the Internet Service Provider's (ISP's) egress point to the Internet. These network caches also benefit the ISPs by alleviating their need for investing in additional bandwidth connecting them to the Internet. A typical network with caches is shown in the prior art drawing of FIG. 1.

As is also known, network caches (or “proxy servers”) have become an integral part of the infrastructure for the ISP's network. Additionally, there is a significant amount of work going on in the Internet Engineering Task Force (IETF) to standardize certain protocols that will enable caches to communicate with application servers and leverage their capabilities to provide services to the end-users.

One such protocol is Internet Content Adaptation Protocol (ICAP), which is a protocol that enables a caching device to communicate with an application server. There are two types of messages that are allowed within the framework of ICAP:

1) Request Modification and

2) Response Modification

The steps involved in Request Modification are:

1) Client generates a web request using Hyper Text Transfer Protocol (HTTP)

2) Cache intercepts the HTTP request and passes the request to an ICAP server using ICAP request modification message

3) ICAP server executes the requested ICAP service and sends back the possibly modified HTTP request to the cache using ICAP

4) The cache sends the modified HTTP request (obtained from step (3)) to the origin server

5) Origin server responds to the request

6) Cache forwards the response to the client

This is shown in the prior art drawing of FIG. 2. The steps involved in Response Modification, on the other hand, are:

1) Client generates a web request using Hyper Text Transfer Protocol (HTTP)

2) Cache intercepts the HTTP request and passes the request to the origin server

3 ) Origin server executes the request and sends the response back

4) The cache forwards the HTTP response to the ICAP server using ICAP

5) ICAP server executes the requested ICAP service and sends the possibly modified response back to the cache using ICAP

6) Cache forwards the response (obtained from step (5)) to the client

This is shown in the prior art drawings of FIG. 3.

There are several examples of services that can be enabled by ICAP, namely, content transformation based on user-agent, content filtering by restricting access to a subset of the web, virus checking of software downloads, etc. However, in order to make available ICAP services in a network, these caches (as well as the application servers) have to be ICAP-enabled. This results in three fundamental problems:

1) In order to make a cache ICAP-enabled, the ICAP protocol has to be implemented and the existing caching software has to be upgraded. This implies that a huge existing base of caches has to be completely replaced with the new generation of ICAP-enabled caches.

2) The second problem pertains to the application servers. The application servers also have to upgrade their software with ICAP in order to make their services available to ISP's end-users via caches.

3) In order to provide ICAP services in an efficient manner, an ISP has to deploy the application servers in their network. Otherwise, the bandwidth saved by using a cache will be offset by the shipment of content between the cache and the application servers across the Internet using the ISP's leased line to the backbone.

### SUMMARY OF THE INVENTION

As will become clear from the description that follows, apparatus (or software which can be loaded into off-the-shelf hardware) according to one aspect of the invention addresses these problems by providing the following functionality:

1) When deployed alongside a “regular” (or non-ICAP-enabled) cache, the apparatus converts the regular cache into an ICAP-enabled cache, thus eliminating the need for changing any caches that are already deployed in a network.

2) When deployed with an application server that does not support ICAP, the apparatus makes the server ICAP-enabled, thereby making its services available to any ICAP-enabled cache

3) The apparatus has the following features to minimize shipping of content across the Internet between the cache and the application server:

a. The apparatus will cache all ICAP responses. Thus if a “modified” response has been brought into the network once for a client, a request for the same modified object will be satisfied from the apparatus' cache

b. The apparatus will provide the most popular services, such as, content transformation, virus checking, content filtering, personalization and ad-insertion.

### BRIEF DESCRIPTION OF THE DRAWINGS

FIGS. 1-3 are the prior art drawings previously referred to;

FIG. 4 is a software architecture representation of the ICAP-enabled apparatus of the invention; and

FIG. 5 illustrates a typical flow of messages helpful in an understanding of the architecture components of FIG. 4.

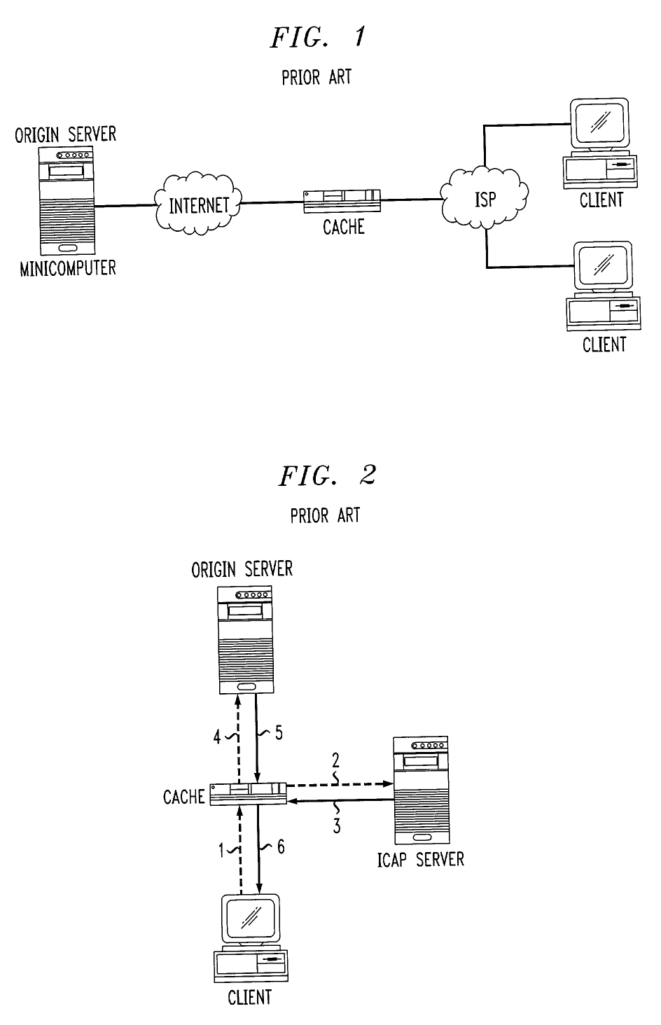

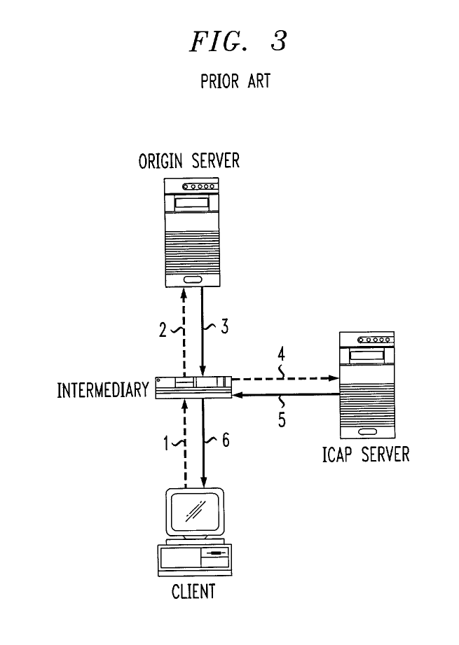

### DETAILED DESCRIPTION OF THE INVENTION

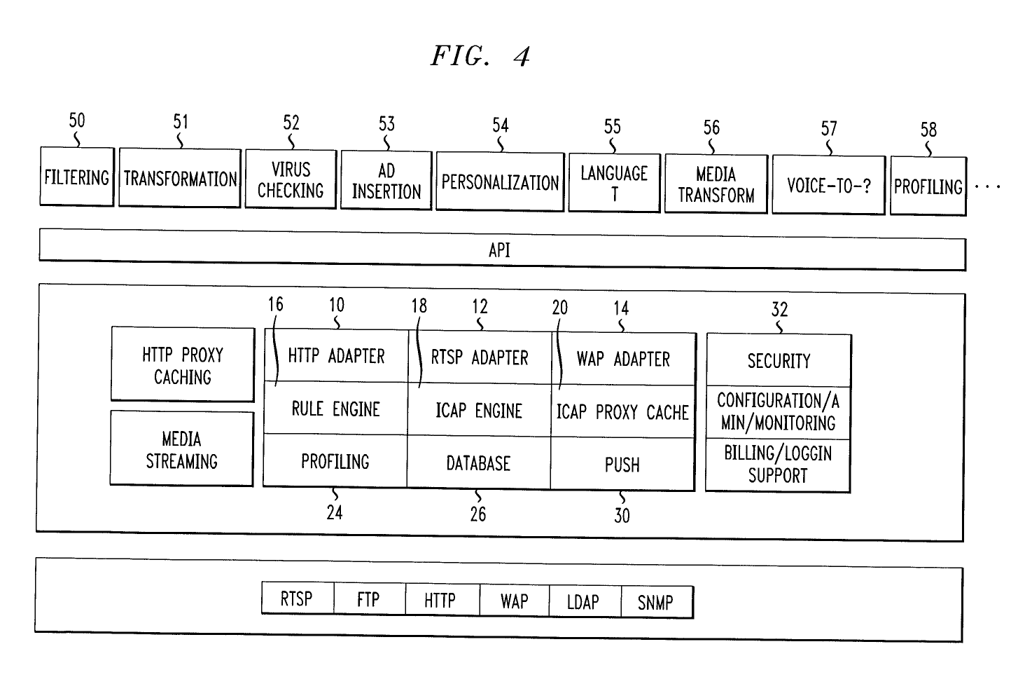

The software architecture of the apparatus of the invention shown in FIG. 4 will be understood to support the following protocols: HTTP, RTSP, FTP, LDAP, SNMP and WAP in addition to supporting ICAP. The apparatus will also support web caching, media object caching, WAP caching and ICAP proxy caching. Thus, if an object is brought in using HTTP, RTSP or any other Streaming protocol (MMS, Real), WAP or ICAP, it will be stored locally for serving future requests.

As shown, the apparatus of the invention includes an HTTP adapter 10, an RTSP adapter 12, a WAP adapter 14, a Rule engine 16, an ICAP engine 18, an ICAP proxy 20, the ICAP client 22, a Profiler 24 and a Database 26. In addition to these, the apparatus will have support for configuration, administration, monitoring, logging, billing and security.

The HTTP adapter 10 is a software module that can take an HTTP request/response and transform that to an ICAP request/response. Thus a cache without ICAP support can be made ICAP-enabled.

The same idea holds true for the RTSP adapter 12 and WAP adapter 14. In other words, a streaming proxy cache using RTSP and with no support for ICAP can take advantage of ICAP services in conjunction with the RTSP adapter 12. An example of such a service is media-encoding transformation, say from MPEG-1 to MPEG-4 or say from MPEG-4 to Real Media. There are several WAP proxy-caches to whom ICAP is a foreign concept. However, if WAP caches could take advantage of ICAP services via a WAP adapter module, they could start providing value-added services. For instance, insertion of advertisement or personalization of a WAP page can be easily provided once the WAP cache becomes ICAP enabled.

The rule engine 16 plays a crucial role in the whole architecture because this module helps determine what kind of rules should be applied to a web request/response. The rules will have a predicate (consisting of a valid logical expression) and an action. For example, a rule for checking virus on a binary application may look like:

| | |
|---|---|
| Predicate: | <property name=“Conten-Type” |
| | matches=“applicatio/”> |
| Action: | icap://mcaffee.com/viruscheck |

Similarly, a rule for language translation may look like:

| | |
|---|---|
| Predicate: | <property name=“Accept-Languages” |
| | matches=“de\hat{ }de\|\hat{ }fr\|\hat{ }it\|\hat{ }es”> |
| Action: | propxylet://localhost/translate?target=de |

Predicates can be based on the Source IP address, Destination IP address, User identity (such as, cookie), Destination url, User profile etc. For instance, a rule for preventing access to pornographic sites for a school (subnet IP address: 172.16.1) may look like:

| | |
|---|---|
| Predicate: | <Source IP: 172.16.1> AND <Destination url is in |
| | Censored url-List> |
| Action: | icap://content-filtering.com/change-url |

Another example for inserting advertisement using ICAP may look like:

| | |
|---|---|
| Predicate: | <Cookie: name=john.doe.state=nj.zip=00707> |
| Action: | icap://ad-insert.com/insert-ad |

The real value of the rule engine would be to have an open interface through which a third-party service provider can insert rules dynamically. For example, an ad-insertion company can insert rules like:

| | |
|---|---|
| Predicate: | <Cookie: name=john.doe.state=nj.zip=00707> |
| Action: | icap://ad-insert.com/insert-ad/clip-10 |

where clip-10 matches the profile of the user. In fact, if clip-10 is stored locally, the ad could have been inserted locally without going out to an ICAP-enabled ad-server in the Internet.

The main advantage of the open interface for rule insertion is that the device can be adapted dynamically based on the needs of the application servers. It'd also be easy to add/delete rules corresponding to new/old application servers.

The ICAP engine 18, in this regard, will implement the ICAP server. In other words, this module will be responsible for handling ICAP requests/responses from clients/servers.

The ICAP proxy module 20, on the other hand, is the one to which every ICAP request is forwarded by the ICAP engine 18. The objective is to check if the requested object is already stored in the ICAP cache. If it is, the response will be generated by the apparatus locally. If not, the request will be forwarded to the respective ICAP server out in the Internet.

The ICAP client module 22 is responsible for generating ICAP requests for the ICAP servers, while the Profiler software module 24 will be used to keep track of individual user's access pattern and based on that information, new rules may be inserted in an “intelligent” manner. For example, if a certain user named John Doe visits “fishing” sites, the device may start inserting “fishing-related ads” whenever he surfs the web. This may be a service that an ISP may sell to “fishing-related content sites”.

(The Profiler software can be used effectively for mobile data users as well. For instance, if a certain user frequently looks around for nightclubs from his PDA, the device may insert information about “local” nightclubs (based on his location) whenever he tries to access the web from his PDA. This opens the door for “location-based” and “profile-based” services to a mobile data user. The Database module 26 will play a significant role in the apparatus of the invention in this respect, starting from keeping simple things like profiles of individual users and rules to complex things like maps and business directory to enable wireless data applications.)

In appreciating the foregoing description, the following should be noted:

a: RTSP: Real Time Streaming Protocol is an Internet Engineering Task Force (IETF) standard protocol (RFC-2325) that is used between a streaming client and a streaming server for controlling streaming of media (audio/video) objects. It runs directly over Transmission Control Protocol (TCP);

b: FTP: File Transfer Protocol is an Internet Engineering Task Force (IETF) standard protocol (RFC-959) that is used for transferring files between two machines on the Internet. It runs directly over TCP;

c: LDAP: Lightweight Directory Access Protocol is an Internet Engineering Task Force (IETF) standard protocol (RFC-1777) that is used for accessing online directory services. It runs directly over TCP;

d: SNMP: Simple Network Management Protocol is an Internet Engineering Task Force (IETF) standard protocol (RFC-1157) that is used for managing network elements. It runs directly over User Datagram Protocol (UDP);

e: WAP: Wireless Access Protocol provides a method to communicate across wireless networks quickly, securely and efficiently. Communication can take place using, but is not limited to, devices such as cell-phones, pagers, two-way radios and personal data assistants. This communication is not limited to static pages; rather, WAP offers the opportunity to integrate databases, dynamic content, e-commerce, and secure information trafficking via a WAP-enabled device. Although the name itself refers to a single protocol, WAP can actually be thought of as a compilation of protocols brought together to cover many aspects of wireless communication;

f: MMS: Microsoft Media Server is Microsoft's proprietary protocol for streaming media objects. MMS is Microsoft's counterpart for RTSP;

g: MPEG: The Moving Picture Experts Group (MPEG) is a working group of ISO/IEC in charge of the development of standards for coded representation of digital audio and video. Established in 1988, the group has produced MPEG-1, the standard on which such products as Video CD and MP3 are based, MPEG-2 the standard on which such products as Digital Television set top boxes and DVD are based and MPEG-4, the standard for multimedia for the web and mobility; and

h: PDA: Personal Digital Assistant is a hand-held device that is used by professionals to hold their contact information and calendar. PDAs are also used for accessing electronic mail and for surfing the web.

FIG. 4 schematically shows a core platform (foundation), Application Programmer's Interface (API) and applications (Services) that can be built on top of the platform.

A. The foundation consists of three parts:

1. A set of standard protocols

2. Core of the invention

3. Wrapper around the core

1. The standard set of protocols included in the platform are the RTSP, FTP, WAP and SNMP protocols noted above, along with the Hyper Text Transfer Protocol (HTTP) which is an Internet Engineering Task Force (IETF) standard protocol (RFC-1945 and RFC-2068) that is used to access web pages on the Internet and which also runs directly over Transmission Control Protocol (TCP).

2. The core of the invention is as has been described previously.

3. The wrapper around the core consists of the following components:

a. HTTP Proxy cache: this software component is traditionally known as a web cache. Every HTTP request from a web browser goes through the HTTP proxy cache. If the proxy cache has the requested object, it can send the object to the web browser without forwarding the request to the origin server. If the requested object is not there at the proxy cache, it forwards the request to the origin server, retrieves the object, stores a copy of the object in the local disk and forwards the object to the web browser. Note that by storing a copy of the object in the local disk, any subsequent request for the same object can be satisfied locally by the proxy cache.

b. Media Streaming cache: this software component serves the same purpose as the HTTP proxy cache except that it does it for the media objects instead of the web objects. Typically the media streaming cache supports RTSP and RTTP (Real Time Transport Protocol:RFC-1889). In order to support streaming of windows media objects, the streaming cache has to support Microsoft Media Server (MMS) protocol.

c. Push: this software component 30 is responsible for “pushing” web/media objects to the web browser/media player without being explicitly requested by the browser media player. This feature is useful for advertisement and alerts.

d. Security: this feature 32 encompasses authentication, authorization, privacy, integrity and digital signatures. Authentication makes sure that the client trying to access content on the platform is really the one it claims itself to be. Authorization is a mechanism to make sure that the authenticated client has the “rightful” access to the content it is trying to access. Privacy is achieved by encrypting the content. Message integrity is ensured by concatenating a message with a unique “message digest” which is computed using standard algorithms, such as, Message Digest Algorithm Number 5:MD5 (RFC-1321) and/or Secure Hash Algorithm: SHA (FIPS 180-1). Digital signatures are needed to prevent fraud in that a message digitally signed by an entity X can be proven to be signed by none other than X. All these features should be built into the platform for secure message exchange when the platform is used as an intermediary between a client and a server.

e. Configuration/Administration/Monitoring: With this feature 34, Configuration refers to setting the right parameters for the platform to function correctly. Administration refers to the capability of adding/deleting/altering the configuration parameters of the platform. Monitoring refers to checking the performance of the platform when the platform is operational in the network.

f. Billing/Logging: With feature 36, Logging is used to track the access history of the platform for detecting potential intrusion and also to record usage for billing potential customers.

B. The Application Programmer's Interface (API) is a mechanism provided for the development of application programs. The core platform (or the foundation) consists of components that can be used as the building blocks of complex applications (or services). API is the glue between the platform and the services. An application programmer can stitch together relevant components of the platform by using the API to build new applications.

C. Applications (or services)

Applications can be built on top of the core platform. The following is a list of potential applications:

1. Filtering 50: this is a simple application that can restrict the accessibility of an end-user to a subset of the web. For example, a company most likely would not want their employees to watch pornographic sites during working hours. Similarly, parents may want to restrict what their children can access on the web. The filtering application will be invoked when certain “rules” (such as, the originating IP address for a given request belongs to a list and the url requested contains the word “sex”) are satisfied and it is the job of the “rule engine” in the core platform to figure out if the rule to trigger the filtering application is satisfied.

2. Transformation 51: this application is responsible for transforming content type. Content transformation is necessary to accommodate the needs of a multitude of end-user devices which differ not only in form factor but also in the processing capability. For example, a web-page rich in color graphics cannot possibly be displayed on the screen of a mobile phone. The transformation application will be invoked when certain “rules” (such as, the request has been originated by a specific type of mobile phone that has a given form factor and that does not support color display) are satisfied and it is the job of the “rule engine” in the core platform to figure out if the rule to trigger the transformation application is satisfied.

3. Virus checking 52: viruses that damage end-systems should be screened before they are downloaded to an end-user's device. There are several application softwares which can do this kind of virus screening. Such an application can be built on top of the core platform and invoked whenever there is an attachment to be downloaded as determined by the rule engine.

4. Ad Insertion 53: this application inserts advertisements based on the end-user profile. When a request arrives at the platform and the rule engine finds that the originating source matches the requirement for the insertion of an advertisement, it invokes the ad-insertion application. For example, on the home page of cnn.com, an ad for a Broadway show can be placed if the request originates from New York while an ad for a special Hollywood event can be placed if the request originates from Los Angeles. The function of the platform would be to detect where the request is coming from and pass on the relevant information to the ad-insertion application for it to insert the appropriate advertisement.

5. Personalization 54: this application is responsible for giving a different look and feel to the same web-page based on the user profile. There are several examples of this in the form of myyahoo.com or myexcite.com in which a user sets her preferences for the information that she is interested in and also the form she wants the information to be displayed. Based on identifying the originator of the request, the rule engine will invoke the personalization application with the relevant information.

6. Language Translation 55: the same web-page can be displayed in different languages, Rule engine can identify the end-user's language preference and invoke the language translation application with the relevant information.

7. Media Translation 56: media objects can be encoded in multiple formats but all end devices may not be capable of decoding all formats. As a result, there are applications (typically called “transcoders”) that translate between multiple formats. For example, if a request is generated from a MPEG-4 client for a media object which exists in RealMedia format, a transcoding from RealMedia to MPEG-4 would be required for the clip to be played. The rule engine can detect that the request is from a MPEG-4 client and hence can trigger the media translation application.

8. Voice to Text 57: voice messages may need to be rendered as text if the request is for a voice message but the originating source is a voice-incapable device like a PDA. Such a voice-to-text application can be triggered by the rule engine as well.

9. Profiling 58: this application can use the “profiler” component of the core platform to generate higher-level profile information for end-users. For example, based on the fact that a given user accesses cnn.sports.com, espn.com and yahoo.sports.com, the profiling application can figure out that the user is a sports fan. That information can either be passed on to advertising agents or can be used for intelligent ad-insertion.

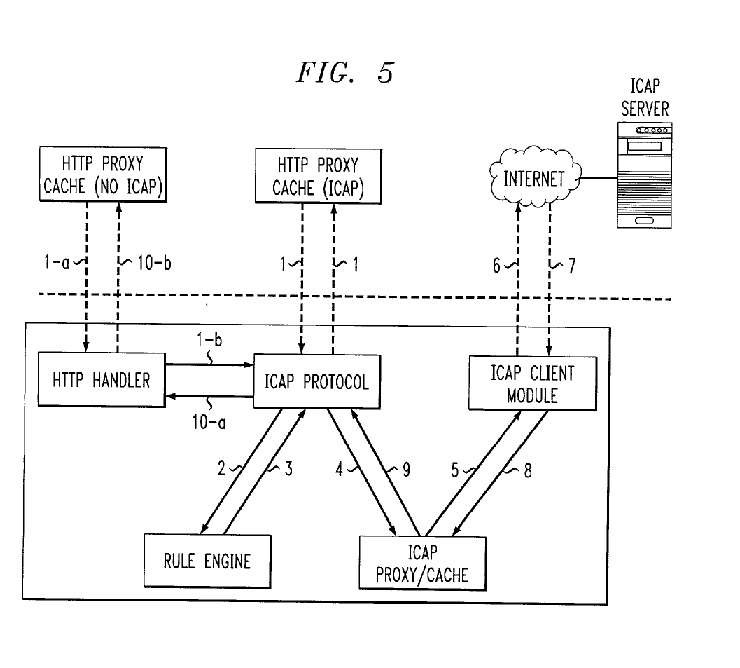

A typical flow of messages between the various components of the architecture is shown in FIG. 5. First, is the ICAP request from the cache 1; then is to check the rule 2, get the rule 3, check if the proxy can satisfy the request 4, and 5, the proxy forwards the ICAP request. Next, the ICAP client forwards the request to the ICAP server 6, the ICAP server sends the response 7, the response is stored in proxy/cache 8, the response forwarded to the ICAP protocol engine 9, and the ICAP protocol engine forwards the response to HTTP Proxy 10, As an example,

1-a: HTTP request from the HTTP Proxy Cache in the
following form:

GET/HTTP/1.1
Host:www.origin-server.com
Accept:test/html, text/plain
Accept-Encoding:compress
Cookie:ff39fk3jur@4ii0e02I
If-None-Match: “xyzzy”, “r2d2xxxx”

1-b: HTTP request is transformed into an ICAP request by
the HTTP Handle as follows:

REQMOD icap://icap-server,net/server?arg=87 ICAP/1.0
Host: icap-server.net
Encapsulated:req-hdr=0
GET/HTTP/1.1
Host:www.origin-server.com
Accept: text/html, text/plain
Accept-Encoding: compress
Cookie: ff39fk3jur@4ii0e02I
If-None-Match: “xyzzy”, “r2d2xxxx”

10-a: ICAP response is forwarded to the HTTP Handler in the
following manner:

ICAP/1.0 200 OK
Date: Mon, 10 Jan 2000 09:55:21 GMT
Server: ICAP-Server-Software/1.0
Connection:close
Encapsulated:req-hdr-0
GET/modified-path HTTP/1.1
Host:www.origin-server.com
Accept: text/html, text/plain, image/gif
Accept-Encoding: gzip,compress”
If-None-Match: “xyzzy”, “r2d2xxxx”

10-b: HTTP Handler, after retrieving the content from the
relevant origin server (www.origin-server.com/modified-path)
sends a HTTP response to the HTTP Proxy cache in the following
manner:

HTTP/1.0 200 OK
Date:Fri, 13 Jul 2001 23:59:59 GMT
Content-Type: text/html
Content-Length:1354
<html>
<body>
<h1>You are not allowed to watch obscene sites!</h1>
(more file contents)
</body>
</html>

While there have been described what are considered to be preferred embodiments of the present invention, it will be appreciated by those skilled in the art that modifications may be made without departing from the scope of the teachings herein. For example, whereas the foregoing description has proceeded in the context of an Internet Service Provider Network deploying a first cache or proxy server employing the HTTP protocol between a user and a server, any one of RTSP, FTP, LDAP, SNMP, and WAP could be used as well. Also, in communications networks other than for the Web, a second cache or proxy server employing a protocol other than ICAP could be used between the first cache and the application server, and operate similarly. For at least such reasons, therefore, resort should be had to the claims appended hereto for a true understanding of the invention.

I claim:

1. In a communications network deploying a first cache between a user and a server, the improvement comprising:
the utilization of a second cache to aggregate user requests and responses according to a protocol between said first cache and an application server.

2. The improvement of claim 1, including a proxy module for checking whether a user request is already stored within said separate cache.

3. The improvement of claim 1 employing a protocol between said user and server selected of any one of the group of HTTP, RTSP, FTP, LDAP, SNMP and WAP.

4. The improvement of claim 1 in an Internet Service Provider Network employing a second cache to aggregate requests and responses according to an Internet Content Adaptation Protocol (ICAP), including means for transforming deployed non-ICAP-enabled caches to an ICAP-enabled cache format.

5. The improvement of claim 4 wherein said means includes an HTTP adapter.

6. The improvement of claim 4, including means for transforming streaming caches to an ICAP-enabled streaming cache format

7. The improvement of claim 4 wherein said means includes an RTSP adapter.

8. The improvement of claim 4, including means for transforming deployed WAP caches to an ICAP-enabled WAP cache format.

9 The improvement of claim 8 wherein said means includes a WAP adapter.

10. The improvement of claim 4, including means for transforming a non-ICAP-enabled application server to an ICAP-enabled application server.

11. The improvement of claim 1, including a rule engine with an open interface for allowing third-party insertion of rules governing responses to user requests.

12. The improvement of claim 11 wherein said rule engine allows dynamic insertion of rules based on the then desires of application servers to the Internet.

13. The improvement of claim 11, including means for tracking individual user access patterns to the Internet.

14. The improvement of claim 13 wherein said means also allows dynamic insertion of rules based on such access patterns of said user to provide profile-based services thereto.

15. The improvement of claim 13, including a database of information to provide location-based services to said user.

16. The improvement of claim 4, also including means for transforming deployed streaming caches to an ICAP-enabled streaming cache format, and means for transforming deployed WAP caches to an ICAP-enabled WAP cache format.

17. The improvement of claim 4, including means for transforming deployed non-ICAP enabled caches to an ICAP-enabled cache format, means for transforming deployed streaming caches to an ICAP-enabled streaming cache format, and means for transforming deployed WAP caches to an ICAP-enabled WAP cache format.

18. The improvement of claim 4, including a rule engine with an open interface for allowing third-party insertion of rules governing responses to user requests.

19. The improvement of claim 1, including an Application Programming Interface (API) for third-party writing of applications for the network.
